(19) United States
(12) Patent Application Publication
(10) Pub. No.: US 2024/0287732 A1
(43) Pub. Date: Aug. 29, 2024

(54) CHEM/BIO FABRIC OR LAYER WITH METAL OXIDE CONTENT

(71) Applicant: Ascend Performance Materials Operations LLC, Houston, TX (US)

(72) Inventors: Kevin Urman, Houston, TX (US); Vikram Gopal, Houston, TX (US)

(73) Assignee: Ascend Performance Materials Operations LLC, Houston, TX (US)

(21) Appl. No.: 18/588,601

(22) Filed: Feb. 27, 2024

Related U.S. Application Data
(60) Provisional application No. 63/487,235, filed on Feb. 27, 2023.

(51) Int. Cl. D06M 11/46; A62B 17/00; D04H 3/16; D06M 11/45

(52) U.S. Cl. CPC D06M 11/46; A62B 17/00; D04H 3/16; D06M 11/45; D10B 2201/02; D10B 2331/02

(57) ABSTRACT

This disclosure relates to a protective fabric having improved chem/bio repellant properties, comprising a nonwoven matrix comprising fibers and metal oxide particles dispersed among the fibers. The nonwoven matrix has an oxide particle retention rate greater than 5%, and the protective fabric demonstrates a flame retardant index greater than 3, as measured in accordance with ISO 14116:2008.

### CROSS-REFERENCE TO RELATED APPLICATION

This application relates to and claims priority to U.S. Provisional Application No. 63/487,235, filed Feb. 27, 2023, the disclosure of which in incorporated herein by reference in its entirety.

### FIELD

The present disclosure relates to a fiber matrix or layer, e.g., for chem/bio protective garments, having improved bio/chem and/or hazmat repellency performance, flame retardancy, and metal oxide particle retention.

### BACKGROUND

Fabrics for protective garments, e.g., hazardous material (hazmat) or chemical/biological (chem/bio) suits, are known. In some cases, spunbond polymer fabrics, either alone or as one of multiple layers, are employed in these garments. For example, U.S. Pat. No. 8,129,450 discloses durable and disposable articles that include a thermoplastic polymer composition, which includes a blend of a polymer and a modified polymer. The modified polymer has covalently bonded pendant substituents derived from cyclodextrin. The articles can be a films, coatings, nonwoven webs, or monolithic articles. An article can have the polymer composition as one part of the article, such as in one distinct area of the article, or on the surface of the article, for example as a coating or surface film. The article can be, for example, a multilayer barrier film, a nonwoven sheet or pad, an absorbent article, or a storage container.

In some cases, polymers may be used as protective barriers against noxious and toxic chemicals. Hazmat suits provide protection for the handlers of these chemicals. First responders, for example fire-rescue personnel, require hazmat suits to respond to industrial accidents involving the aforementioned chemicals. Both law enforcement and the military also use hazmat suits in case of chemical attacks. Breathable impervious protective garments employing a breathable structure that, for example, combines spunbond/meltblown/spunbond (SMS) nonwoven fabric results in excellent barrier performance while still providing the breathability necessary to provide for the comfort needs of a worker.

Polymer compositions used to make fabrics/fibers are well known. U.S. Pat. No. 5,616,408 B2 discloses a nonwoven web of meltblown microfibers formed of a composition of polyethylene and at least one component added to provide processing stability to the polyethylene component. The meltblown web can be produced at high polymer throughputs and exhibits good barrier properties. The meltblown web is useful as a component of a composite fabric, which can be used for barrier application in medical and industrial applications.

Formulations and coatings of some oxides is also known. For example, U.S. Pat. No. 8,758,501 discloses nanoparticulate UV protectants that are obtainable by hydrothermal treatment of a nanoparticulate metal oxide and subsequent application of a silicon dioxide coating, and to the preparation and use thereof. It further relates to novel compositions, in particular for topical application, which are intended, in particular, for light protection of the skin and/or of the hair against UV radiation, and to the use thereof in the above-mentioned cosmetic application.

Even in view of these references, the need exists for improved chem-bio protective fabrics that have the added protection of metal oxide particles and that demonstrate the synergistic combination of performance features, e.g., chem/bio repellency performance and metal oxide particle retention.

### SUMMARY

In some cases, the present disclosure relates to a protective fabric having improved chem/bio repellant properties, comprising a fiber matrix, preferable a nonwoven fiber matrix, e.g., a spunbond fabric, comprising fibers; and metal oxide particles, e.g., aluminum oxide or titanium oxide or combinations thereof, optionally having an average particle diameter less than 2 microns, dispersed among the fibers, e.g., embedded among the fibers; wherein the fiber matrix has a metal oxide particle retention rate greater than 5%; and wherein the protective fabric demonstrates a flame retardant index greater than 2, as measured in accordance with ISO 14116:2008. The fibers may comprise first fibers made from a first fiber/fabric composition comprising a first polymer, preferably a polyamide and/optionally second fibers made from a second fiber/fabric composition comprising a second component, preferably cotton. The disclosure also relates to a chem/bio garment comprising the protective fabric.

In some cases, the present disclosure relates to a process for making the protective fabric (or a layer), the process comprising embedding metal oxide particles into a fiber matrix of fibers to yield the protective fabric. The embedding may comprise providing the fiber matrix and adding the metal oxide particles to the fiber matrix to form an intermediate matrix and, optionally needle punching the intermediate matrix to embed the metal oxide particles therein or the embedding may comprise sandwiching metal oxide particles between a first fiber matrix and a second fiber matrix to form an intermediate matrix and needle punching the intermediate matrix to embed the metal oxide particles therein or the embedding may comprise hydroentangling the fibers and adding the metal oxide particles to the hydroentangled fibers or the embedding may comprise adding the metal oxide particles to the fiber matrix to form an intermediate matrix and pressurizing the intermediate matrix to embed the metal oxide particles therein. The process may further comprise forming the protective fabric into a chem/bio garment.

### DETAILED DESCRIPTION

### Introduction

As discussed above, it is known to make fabric from polyesters and olefins such as polyethylene and polypropylene and to use these fabrics to make hazmat or chem/bio protective garments. However, these conventional fabrics suffer from performance problems such as comfort, moisture management, and loss due to abrasion. These conventional fabrics also lack protection features provided by metal oxide particles. In addition, some conventional chem/bio fabrics employ a coating to provide improved functionality. However, it has been found that such coatings are problematic because they are easily removed, e.g., rubbed off, from the based fabric, which removes the oxides and, as a result, removes to functionality associated therewith. Further, the displaced coatings have extremely deleterious effects when they leach from the coated garment onto the adjacent skin.

It has now been discovered that active ingredients may be effectively embedded into a fiber matrix, e.g. a nonwoven fiber matrix. A fiber matrix comprising fibers and metal oxide particles, as disclosed herein, provides for a synergistic combination of performance features, e.g., metal oxide functionality, chem/bio repellency performance, flame retardancy, and metal oxide particle retention. The disclosed fabrics or layers have been found to outperform conventional fabrics that do not employ the metal oxide particles in the aforementioned configuration or that employ the a metal oxide coating, which have the retention problems mentioned above.

Without being bound by theory, it is postulated that the metal oxide particles are embedded in the fibers or entangled among the fibers such that the metal oxide particles are effectively secured therein. As such, the metal oxide particles are present and able to provide the performance features discussed herein. Without this configuration of fibers and particles, the retention of the metal oxide particles would be detrimentally reduced, e.g., because the metal oxide particles are no longer present.

The disclosure relates to a protective fabric or layer having improved chem/bio repellant properties. The protective fabric comprises a particular fiber matrix, e.g., a nonwoven fiber matrix, that comprises fibers and metal oxide particles. The metal oxide particles are embedded among the fibers or dispersed among the fibers (versus all of the particles being present as a coating). As a result, the fiber matrix has a metal oxide particle retention rate greater than 5%. And the fiber matrix (or the protective fabric that comprises the fiber matrix) demonstrates a flame retardant index greater than 3, as measured in accordance with ISO 14116:2008. Additional performance features are disclosed herein.

In some cases, the layer may be used as a component of a chem/bio or hazmat garment, however, many other applications and uses are contemplated. For example, the protective fabric or layer may be employed in filtration, medical clothing, emergency materials, absorbent structures, cleaning products, e.g., wet wipes, acoustics, packaging materials, and/or tarps.

The fiber matrix may vary widely, as long as the fiber matrix comprises fibers have spaces in between to allow for the metal oxide particles to be disposed. In some cases, the fiber matrix is a nonwoven matrix. It has been discovered that a nonwoven matrix is particularly effective in providing for the inter-fiber spacing that provides for the retention of the metal oxide particles. Exemplary nonwoven matrices include, but is not limited to, meltblown, electrospun, spunlace, needlepunch, and spunbond matrices.

In some embodiments, the fiber matrix is formed via melt spinning or melt blowing. In some embodiments, the fiber matrix is formed via solution spinning. In some embodiments, the fiber matrix is formed via spunbonding. Conventional methods of preparing a fiber matrix may be employed to form nonwoven products. Exemplary methods are disclosed in U.S. Pat. No. 10,662,561, which is incorporated herein by reference.

In some cases, the fiber matrix has a metal oxide particle retention rate greater than 5%, e.g., greater than 10%, greater than 20%, greater than 30%, greater than 40%, greater than 50%, greater than 60%, greater than 70%, greater than 80%, greater than 90%, or greater than 95%. The retention rate may be calculated by measuring the metal oxide particle retention after a predetermined time or predetermined contact time with a sample substrate or a predetermined number of water wash cycles. This may be done by measuring the weight of the fiber matrix or the protective fabric before and after and calculating the loss of metal oxide particles based on the difference.

In addition to the protective fabric and the fiber matrix, the disclosure also relates to a chem/bio garment comprising the fiber matrix alone or as a fabric layer. Thus, the aforementioned protective fabric may be formed into the chem/bio garment.

### Metal Oxide Particles

The chemistry and structure of the metal oxide particles may vary widely. In some cases the metal oxide particles may comprise oxides of aluminum, titanium, silver, zinc, zirconium, thorium, magnesium, silicon, iron, copper, nickel, cobalt, aluminum, gold, manganese, magnesium. In some embodiments, the metal oxide comprises aluminum oxide and/or titanium oxide.

The performance/functionality provided by the metal oxide particles may be to mitigate, reduce, inactivate, and/or render harmless biological/chemical agents and/or hazardous materials.

The metal oxide particles may have any average particle diameter suitable for the intended use. For example, the metal oxide particles may have an average particle diameter less than 50 microns, e.g., less than 40 microns, less than 30 microns, less than 25 microns, less than 20 microns, less than 18 microns, less than 17 microns, less than 15 microns, less than 12 microns, less than 10 microns, less than 7 microns, less than 5 microns, less than 3 microns, less than 2 microns, less than 1 microns, or less than 0.5 microns. In some embodiments, the metal oxide particles have an average particle diameter of greater than 1 micron. For example, the average particle diameter of the microparticles may be greater than 1 micron, e.g., greater than 2 microns, greater than 5 microns, or greater than 10 microns. In terms of upper limits, the average particle diameter of the microparticles may have an average fiber diameter of less than 20 microns, e.g., less than 15 microns, less than 10 microns, or less than 5 microns. In terms of ranges, the average particle diameter of the microfibers may be from 1 to 50 microns, e.g., from 2 to 25 microns, or from 5 to 10 microns.

In some embodiments, the metal oxide particles have an average particle diameter of less than 2 microns. For example, the average particle diameter of the nanoparticles may be less than 2 micron, e.g., less than 1.5 microns, less than 1 micron, less than 0.9 microns, less than 0.8 microns, less than 0.7 microns, less than 0.6 microns, less than 0.5 microns, less than 0.4 microns, less than 0.3 microns, less than 0.2 microns, less than 0.1 microns, less than 0.05 microns, less than 0.04 microns, or less than 0.3 microns. In terms of lower limits, the average particle diameter of the nanoparticles may be greater than 0.001 micron, e.g., greater than 0.01 microns, greater than 0.05 microns, greater than 0.1 microns, greater than 0.5 microns. In terms of ranges, the average particle diameter of the nanoparticles may be from 0.001 to 1 micron, e.g., from 0.01 to 0.9 microns, or from 0.1 to 0.80 microns.

### Fiber/Fabric Polymer Composition

As noted above, the fiber/fabric composition comprises a polymer along with other optional components that provide additional performance features, e.g., flame retardants. In some cases, the fibers comprise all fibers made from a single type of polymer. In some cases, the fibers comprise multiple types of fibers.

### Polymer

The fiber/fabric composition comprises a polymer, which, in some embodiments, is a polymer suitable for producing fibers and fabrics. In one embodiment, the polymer composition comprises a polymer in an amount ranging from 50 wt. % to 100 wt. %, e.g., from 50 wt. % to 99.99 wt. %, from 50 wt. % to 99.9 wt. %, from 50 wt. % to 99 wt. % from 55 wt. % to 100 wt. %, from 55 wt. % to 99.99 wt. %, from 55 wt. % to 99.9 wt. %, from 55 wt. % to 99 wt. %, from 60 wt. % to 100 wt. %, from 60 wt. % to 99.99 wt. %, from 60 wt. % to 99.9 wt. %, from 60 wt. % to 99 wt. %., from 65 wt. % to 100 wt. %, from 65 wt. % to 99.99 wt. %, from 65 wt. % to 99.9 wt. %, or from 65 wt. % to 99 wt. %. In terms of upper limits, the polymer composition may comprise less than 100 wt. % of the polymer, e.g., less than 99.99 wt. %, less than 99.9 wt. %, or less than 99 wt. %. In terms of lower limits, the polymer composition may comprise greater than 50 wt. % of the polymer, e.g., greater than 55 wt. %, greater than 60 wt. %, or greater than 65 wt. %.

The polymer of the fiber/fabric polymer composition may vary widely. The polymer may include but is not limited to, a thermoplastic polymer, polyester, nylon, rayon, polyamide 6, polyamide 6,6, polyethylene (PE), polypropylene (PP), polyethylene terephthalate (PET), polyethylene terephthalate glycol (PETG), co-PET, polybutylene terephthalate (PBT) polylactic acid (PLA), and polytrimethylene terephthalate (PTT). In some embodiments, the polymer may be polyamide, e.g., PA6 and/or PA6,6. In some cases, nylon is known to be a stronger fiber than PET and exhibits a non-drip burning characteristic that is beneficial, e.g., in automotive textile applications, and is more hydrophilic than PET. In some cases, the polymer comprises a polyamide and/or a polyester, e.g., a polyamide or a polyester.

In some cases, the polymer composition may comprise polyamides. Common polyamides include nylons and aramids. For example, the polyamide may comprise PA-4T/41; PA-4T/61; PA-5T/51; PA-6; PA6,6; PA6,6/6; PA6,6/6T; PA-6T/61; PA-6T/61/6; PA-6T/6; PA-6T/61/66; PA-6T/MPMDT (where MPMDT is polyamide based on a mixture of hexamethylene diamine and 2-methylpentamethylene diamine as the diamine component and terephthalic acid as the diacid component); PA-6T/66; PA-6T/610; PA-10T/612; PA-10T/106; PA-6T/612; PA-6T/10T; PA-6T/101; PA-9T; PA-10T; PA-12T; PA-10T/101; PA-10T/12; PA-10T/11; PA-6T/9T; PA-6T/12T; PA-6T/10T/61; PA-6T/61/6; PA-6T/61/12; and copolymers, blends, mixtures and/or other combinations thereof. Additional suitable polyamides, additives, and other components are disclosed in U.S. patent application Ser. No. 16/003,528. In some cases, the polymer comprises PA6, or PA 6,6, or combinations thereof.

The polymer composition may also comprise polyamides produced through the ring-opening polymerization or polycondensation, including the copolymerization and/or copolycondensation, of lactams. Without being bound by theory, these polyamides may include, for example, those produced from propriolactam, butyrolactam, valerolactam, and caprolactam. For example, in some embodiments, the polyamide is a polymer derived from the polymerization of caprolactam. In those embodiments, the polymer comprises at least 10 wt. % caprolactam, e.g., at least 15 wt. %, at least 20 wt. %, at least 25 wt. %, at least 30 wt. %, at least 35 wt. %, at least 40 wt. %, at least 45 wt. %, at least 50 wt. %, at least 55 wt. %, or at least 60 wt. %. In some embodiments, the polymer includes from 10 wt. % to 60 wt. % of caprolactam, e.g., from 15 wt. % to 55 wt. %, from 20 wt. % to 50 wt. %, from 25 wt. % to 45 wt. %, or from 30 wt. % to 40 wt. %. In some embodiments, the polymer comprises less than 60 wt. % caprolactam, e.g., less than 55 wt. %, less than 50 wt. %, less than 45 wt. %, less than 40 wt. %, less than 35 wt. %, less than 30 wt. %, less than 25 wt. %, less than 20 wt. %, or less than 15 wt. %. Furthermore, the polymer composition may comprise the polyamides produced through the copolymerization of a lactam with a nylon, for example, the product of the copolymerization of a caprolactam with PA6,6.

In some embodiments, the polymer can formed by conventional polymerization of the polymer composition in which an aqueous solution of at least one diamine-carboxylic acid salt is heated to remove water and effect polymerization to form an antiviral nylon. This aqueous solution is preferably a mixture which includes at least one polyamide-forming salt in combination with the other components described herein to produce a polymer composition. Conventional polyamide salts are formed by reaction of diamines with dicarboxylic acids with the resulting salt providing the monomer. In some embodiments, a preferred polyamide-forming salt is hexamethylenediamine adipate (nylon 6,6 salt) formed by the reaction of equimolar amounts of hexamethylenediamine and adipic acid.

In some embodiments, the polyamide comprises a combination of PA-6, PA6,6, and PA6,6/6T. In these embodiments, the polyamide may comprise from 1 wt. % to 99 wt. % PA-6, from 30 wt. % to 99 wt. % PA6,6, and from 1 wt. % to 99 wt. % PA6,6/6T. In some embodiments, the polyamide comprises one or more of PA-6, PA6,6, and PA6,6/6T. In some aspects, the polymer composition comprises 6 wt. % of PA-6 and 94 wt. % of PA6,6. In some aspects, the polymer composition comprises copolymers or blends of any of the polyamides mentioned herein.

In some cases, the polymer compositions may comprise polyethylene. Suitable examples of polyethylene include linear low-density polyethylene (LLDPE), low-density polyethylene (LDPE), medium-density polyethylene (MDPE), high-density polyethylene (HDPE), and ultra-high-molecular-weight polyethylene (UHMWPE).

In some cases, the polymer compositions may comprise polycarbonate (PC). For example, the polymer composition may comprise a blend of polycarbonate with other polymers, e.g., a blend of polycarbonate and acrylonitrile butadiene styrene (PC-ABS), a blend of polycarbonate and polyvinyl toluene (PC-PVT), a blend of polycarbonate and polybutylene terephthalate (PC-PBT), a blend of polycarbonate and polyethylene terephthalate (PC-PET), or combinations thereof.

The polymer composition may, in some embodiments, comprise a combination of polymers, e.g., a combination polyamides and/or polyesters. By combining various polyamides, the final composition may be able to incorporate the desirable properties, e.g., mechanical properties, of each constituent.

In some embodiments, the fibers comprise multiple types of fibers, e.g., first fibers such as polyamide fibers and second fibers such as cotton fibers. In these cases the first fibers be made from (may comprise) a first fiber/fabric composition comprising a first polymer, and the second fibers be made from (may comprise) a second fiber/fabric composition comprising a second polymer. Additional fibers are contemplated in the fiber matrix, e.g., third fibers, fourth fibers, and so on. In some embodiments, the first fibers may be made from a first fiber/fabric composition comprising a polyamide. In some embodiments, the second fibers may be made from a second fiber/fabric composition comprising cotton or an olefin polymer.

In some cases, the fibers may be made from AM/AV polymer compositions, and as such, will have AM/AV properties. AM/AV polymer compositions and fibers, filaments, yarns, matrices, and fabrics made there from are described, for example in U.S. Pat. Nos. 11,185,071; 11,505,701; and 10,662,561, along with U.S. patent application Ser. Nos. 17/192,491; 17/192,513; and Ser. No. 17/192,533 (and all of their respective progenies), all of which are incorporated by reference herein.

In some embodiments, the RV of the fiber/fabric polymer composition (as measured via the formic acid method) ranges from 5 to 100, e.g., from 5 to 80, from 10 to 70, from 15 to 65, from 20 to 60, from 30 to 50, from 10 to 35, from 10 to 20, from 60 to 70, from 50 to 80, from 40 to 50, from 30 to 60, from 5 to 30, or from 15 to 32. In terms of lower limits, the RV of the fiber/fabric polymer composition may be greater than 5, e.g., greater than 10, greater than 15, greater than 20, greater than 25, greater than 27.5, or greater than 30. In terms of upper limits, the RV of the fiber/fabric polymer composition may be less than 200, e.g., less than 150, less than 125, less than 100, less than 90, less than 75, less than 65, less than 60, less than 50, less than 40, or less than 35. The relative of the fabric/fiber polymer composition contributes to processability and to the mechanical performance.

To calculate RV, a polymer may be dissolved in a solvent (usually formic or sulfuric acid), the viscosity is measured, then the viscosity is compared to the viscosity of the pure solvent. This give a unitless measurement. Solid materials, as well as liquids, may have a specific RV. The fibers/fabrics produced from the polymer compositions may have the aforementioned relative viscosities, as well.

In some embodiments, the fiber/fabric composition (or the fiber/yarn/fabric made therefrom) has a fabric weight less than 300 g/m², at a thickness of less than 0.35 mm, e.g., less than 290 g/m², less than 275 g/m², less than 270 g/m², less than 250 g/m², less than 235 g/m², less than 225 g/m², less than 220 g/m², less than 210 g/m², less than 200 g/m², less than 190 g/m², or less than 175 g/m². In some cases, the fiber/fabric composition (or the fiber/yarn/fabric made therefrom) has a fabric weight greater than 1 g/m², e.g., greater than 3 g/m², greater than 5 g/m², greater than 10 g/m², greater than 25 g/m², greater than 50 g/m², greater than 75 g/m², or greater than 00 g/m².

The fabric (or yarn that make up the fabrics) may comprise fibers, and in some cases, may comprise multiple types of fibers (see discussion he regarding types of polymers).

### Additional Components

In some embodiments, the polymer composition may comprise additional additives. The additives include pigments, hydrophilic or hydrophobic additives, anti-odor additives, additional antiviral agents, and antimicrobial/anti-fungal inorganic compounds, such as copper, zinc, tin, and silver.

In some embodiments, the polymer composition can be combined with color pigments for coloration for the use in fabrics or other components formed from the polymer composition. In some aspects, the polymer composition can be combined with UV additives to withstand fading and degradation in fabrics exposed to significant UV light. In some aspects, the polymer composition can be combined with additives to make the surface of the fiber hydrophilic or hydrophobic. In some aspects, the polymer composition can be combined with a hygroscopic material, e.g., to make the fiber, fabric, or other products formed therefrom more hygroscopic. In some aspects, the polymer composition can be combined with additives to make the fabric flame retardant or flame resistant. In some aspects, the polymer composition can be combined with additives to make the fabric stain resistant. In some aspects, the polymer composition can be combined with pigments with the antimicrobial compounds so that the need for conventional dyeing and disposal of dye materials is avoided.

In some embodiments, the polymer composition may further comprise colored materials, such as carbon black, copper phthalocyanine pigment, lead chromate, iron oxide, chromium oxide, and ultramarine blue.

Fillers may also be employed to the extent desired. Fillers are not required components. Many fillers are known including, but not limited to, glass fibers, such as E, A, C, ECR, R, S, D, and NE glasses and quartz, and the like may be used as the reinforcing filler. Other suitable glass fibers include milled glass fiber, chopped glass fiber, and long glass fiber (for instance those used in a pultrusion process). Other suitable inorganic fibrous fillers include those derived from blends comprising at least one of aluminum silicates, aluminum oxides, magnesium oxides, and calcium sulfate hemihydrate. Also included among fibrous fillers are single crystal fibers or “whiskers” including silicon carbide, alumina, boron carbide, iron, nickel, or copper. Other suitable inorganic fibrous fillers include carbon fibers, stainless steel fibers, metal coated fibers, and the like.

The fiber/fabric composition may comprise flame retardant. Flame retardants are generally well-known.

Some examples of flame retardants include phosphinate metal salts and/or diphosphinate metal salts. Suitable phosphinate metal salts and diphosphinate metal salts include, for example a phosphinate of the formula (I), a diphosphinate of the formula (II), polymers of the foregoing, or a combination thereof

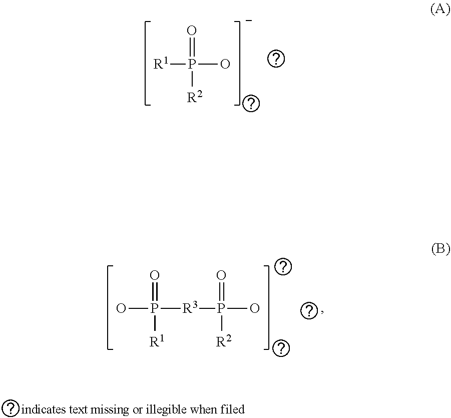

wherein R¹ and R² are each independently hydrogen, a linear or branched C₁-C₆ alkyl radical, or aryl radical; R³ is a linear or branched C₁-C₁₀ alkylene, arylene, alkylarylene, or arylalkylene radical; M is calcium, aluminum, magnesium, strontium, barium, or zinc; m is 2 or 3; n is 1 when x is 1 and m is 2; n is 3 when x is 2 and m is 3. Exemplary commercial products include Exolit OP1230 from Clariant.

Phosphinic salts or phosphinates may include salts of phosphinic and diphosphinic acids and polymers thereof. Exemplary phosphinic acids as a constituent of the phosphinic salts include dimethylphosphinic acid, ethylmethylphosphinic acid, diethylphosphinic acid, methyl-n-propylphosphinic acid, methanedi(methylphosphinic acid), benzene-1,4-(dimethylphosphinic acid), methylphenylphosphinic acid and diphenylphosphinic acid. The salts of the phosphinic acids of the invention can be prepared by known methods that are described in U.S. Pat. Nos. 5,780,534 and 6,013,707.

Exemplary phosphinate metal salts and/or diphosphinate metal salts include aluminum salt of dimethylphosphinic acid, aluminum salt of methylethylphosphinic acid, aluminum salt of methylpropylphosphinic acid.

The flame retardant can optionally contain at least one nitrogen compound selected from the group consisting of condensation products of melamine and/or reaction products of condensation products of melamine with phosphoric acid, and/or mixtures thereof, including for example melam, melem, melon, melamine, melamine cyanurate, melamine phosphate compounds, dimelamine phosphate and/or melamine pyrophosphate, melamine polyphosphate compounds, benzoguanamine compounds, terepthalic ester compounds of tris(hydroxyethyl)isocyanurate, allantoin compounds, glycoluril compounds, ammeline, ammelide, and combinations thereof.

Suitable nitrogen compounds include those of the formula (III) to (VIII) or combinations thereof

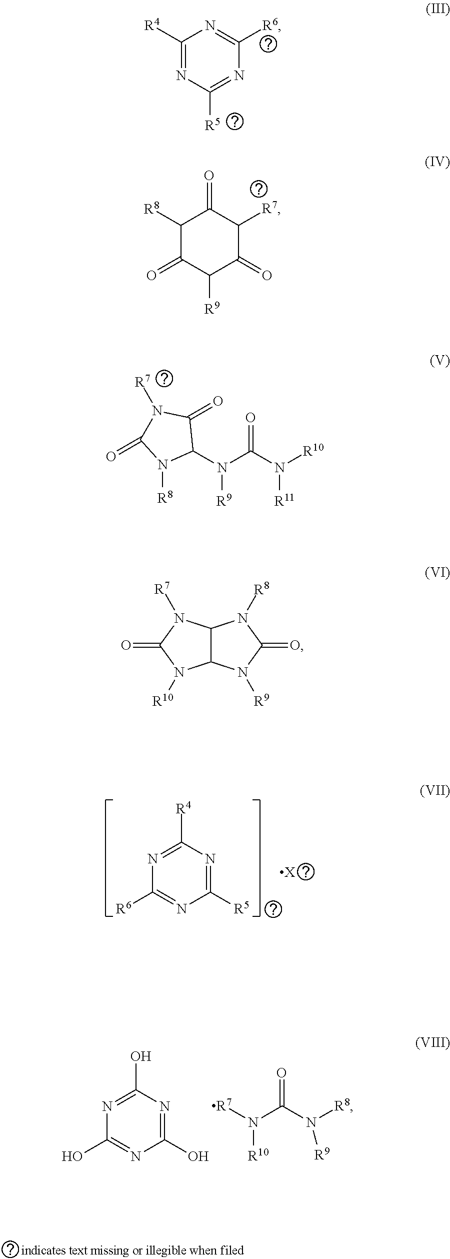

wherein R⁴, R⁵, and R⁶ are independently hydrogen, hydroxy, amino, or mono- or diC1-C₈ alkyl amino; or C₁-C₈ alkyl, C₅-C₁₆cycloalkyl, -alkylcycloalkyl, wherein each may be substituted by a hydroxyl or a C₁-C₄hydroxyalkyl, C₂-C₈ alkenyl, C₁-C₈ alkoxy, -acyl, -acyloxy, C₆-C₂ aryl, —OR¹² and —N(R¹²)R¹³ wherein R¹² and R¹³ are each independently hydrogen, C₁-C₈ alkyl, C₅-C₁₆cycloalkyl, or -alkylcycloalkyl; or are N-alicyclic or N-aromatic, where N-alicyclic denotes cyclic nitrogen containing compounds such as pyrrolidine, piperidine, imidazolidine, piperazine, and N-aromatic denotes nitrogen containing heteroaromatic ring compounds such as pyrrole, pyridine, imidazole, pyrazine; R⁷, R⁸, R⁹, R¹⁰ and R¹¹ are independently hydrogen, C₁-C₈ alkyl, C₅-C₁₆cycloalkyl or -alkyl(cycloalkyl), each may be substituted by a hydroxyl or a C₁-C₄hydroxyalkyl, C₂-C₈ alkenyl, C₁-C₈ alkoxy, -acyl, -acyloxy, C₆-C₁₂ aryl, and —O—R¹²; X is phosphoric acid or pyrophosphoric acid; q is 1, 2, 3, or 4; and b is 1, 2, 3, or 4.

Exemplary nitrogen compounds include allantoin, benzoguanaine, glycoluril, melamine, melamine cyanurate, melamine phosphate, melamine pyrophosphate, melamine polyphosphate, urea cyanurate. Other exemplary flame retardant systems are disclosed in U.S. Pat. No. 6,365,071.

In one embodiment, the polymer composition comprises the additives (individually or in total) in an amount ranging from 0.01 wt. % to 30 wt. %, e.g., 0.1 wt. % to 25 wt. %, from 0.1 to 15 wt. %, from 0.5 wt. % to 10 wt. %, from 1 wt. % to 10 wt. %, or from 1 wt. % to 8 wt. %. In terms of upper limits, the polymer composition may comprise less than 30 wt. % additives, e.g., less than 25 wt. %, less than 20 wt. %, less than 15 wt. %, less than 10 wt %, less than 8 wt %, less than 5 wt %, less than 3 wt %, or less than 1 wt %. In terms of lower limits, the polymer composition may comprise greater than 0.01 wt. % delusterant, e.g., greater than 0.05 wt. %, greater than 0.1 wt. %, greater than 0.5 wt. %, greater than 1 wt %, or greater than 3 wt %.

### Method of Making Fibers and Fabrics

The fibers/fabrics may be formed from the fiber/fabric composition. And the method and steps for producing the fibers/fabrics/matrices themselves may vary widely. Exemplary non-limiting processes are discussed below. As noted above, these processes differ from those employed to product molded products.

Exemplary processes for making a protective fabric (that dispose the metal oxide particles in the fiber matrix) include the step of embedding metal oxide particles into the fiber matrix of fibers to yield the aforementioned protective fabric.

The embedding step may vary widely and many embedding techniques may be employed to arrive at the fiber/particle configuration disclosed herein.

For example, the embedding step may comprise the steps of adding the metal oxide particles to the fiber matrix to form an intermediate matrix and pressurizing the intermediate matrix to embed the metal oxide particles therein. The pressurization may be achieved via many techniques as long as some of the metal oxide particles are sufficiently forced into the fiber matrix.

In some cases, the embedding step comprises providing the fiber matrix and adding the metal oxide particles to the fiber matrix to form an intermediate matrix. The intermediate matrix may be further processed to achieve the fiber/particle configuration. For example, the process may comprise needle punching the intermediate matrix to embed the metal oxide particles therein.

In some embodiments, the process comprises the steps of sandwiching metal oxide particles between a first fiber matrix and a second fiber matrix to form an intermediate matrix; and needle punching the intermediate matrix to embed the metal oxide particles therein.

In some cases, the process comprises the steps of hydroentangling the fibers and adding the metal oxide particles to the hydroentangled fibers, optionally followed by needle punching the intermediate matrix of hydroentangled fibers to embed the metal oxide particles therein.

As noted above, the fibers or fabrics are made by forming the fiber/fabric polymer composition into the fibers, which are arranged to form the fabric or matrix.

All or some of the ingredients may be added initially to the processing system, or else certain additives may be precompounded with one or more of the primary components. The other ingredients may include some of the polymer used to prepare the composition, while the remaining portion of the polymer is fed through a port downstream. This disclosure contemplates the reaction products of the above-described compositions, including the crosslinked products.

In one embodiment, the polymer, crosslinking agent, and little or no flame retardant may be combined to form a blend.

In some aspects, fibers, e.g., polyamide fibers, are made by spinning a polyamide composition formed in a melt polymerization process. During the melt polymerization process of the polyamide composition, an aqueous monomer solution, e.g., salt solution, is heated under controlled conditions of temperature, time and pressure to evaporate water and effect polymerization of the monomers, resulting in a polymer melt. During the melt polymerization process, sufficient amounts of components are employed in the aqueous monomer solution to form the polyamide mixture before polymerization. The monomers are selected based on the desired polyamide composition. The polymerized polyamide can subsequently be spun into fibers, e.g., by melt, solution, centrifugal, or electro-spinning.

In some embodiments, the process includes preparing an aqueous monomer solution. The aqueous monomer solution may comprise amide monomers. In some embodiments, the concentration of monomers in the aqueous monomer solution is less than 60 wt %, e.g., less than 58 wt %, less than 56.5 wt %, less than 55 wt %, less than 50 wt %, less than 45 wt %, less than 40 wt %, less than 35 wt %, or less than 30 wt %. In some embodiments, the concentration of monomers in the aqueous monomer solution is greater than 20 wt %, e.g., greater than 25 wt %, greater than 30 wt %, greater than 35 wt %, greater than 40 wt %, greater than 45 wt %, greater than 50 wt %, greater than 55 wt %, or greater than 58 wt %. In some embodiments, the concentration of monomers in the aqueous monomer solution is in a range from 20 wt % to 60 wt %, e.g., from 25 wt % to 58 wt %, from 30 wt % to 56.5 wt %, from 35 wt % to 55 wt %, from 40 wt % to 50 wt %, or from 45 wt % to 55 wt %. The balance of the aqueous monomer solution may comprise water and/or additional additives. In some embodiments, the monomers comprise amide monomers including a diacid and a diamine, e.g., nylon salt.

In some embodiments, the aqueous monomer solution is a nylon salt solution. The nylon salt solution may be formed by mixing a diamine and a diacid with water. For example, water, diamine, and dicarboxylic acid monomer are mixed to form a salt solution, e.g., mixing adipic acid and hexamethylene diamine with water. In some embodiments, the diacid may be a dicarboxylic acid and may be selected from the group consisting of oxalic acid, malonic acid, succinic acid, glutaric acid, pimelic acid, adipic acid, suberic acid, azelaic acid, sebacic acid, undecanedioic acid, dodecandioic acid, maleic acid, glutaconic acid, traumatic acid, and muconic acid, 1,2- or 1,3-cyclohexane dicarboxylic acids, 1,2- or 1,3-phenyl enediacetic acids, 1,2- or 1,3-cyclohexane diacetic acids, isophthalic acid, terephthalic acid, 4,4′-oxybisbenzoic acid, 4,4-benzophenone dicarboxylic acid, 2,6-napthalene dicarboxylic acid, p-t-butyl isophthalic acid and 2,5-furandicarboxylic acid, and mixtures thereof. In some embodiments, the diamine may be selected from the group consisting of ethanol diamine, trimethylene diamine, putrescine, cadaverine, hexamethyelene diamine, 2-methyl pentamethylene diamine, heptamethylene diamine, 2-methyl hexamethylene diamine, 3-methyl hexamethylene diamine, 2,2-dimethyl pentamethylene diamine, octamethylene diamine, 2,5-dimethyl hexamethylene diamine, nonamethylene diamine, 2,2,4- and 2,4,4-trimethyl hexamethylene diamines, decamethylene diamine, 5-methylnonane diamine, isophorone diamine, undecamethylene diamine, dodecamethylene diamine, 2,2,7,7-tetramethyl octamethylene diamine, bis(p-aminocyclohexyl)methane, bis(aminomethyl)norbornane, C₂-C₁₆ aliphatic diamine optionally substituted with one or more C₁ to C₄ alkyl groups, aliphatic polyether diamines and furanic diamines, such as 2,5-bis(aminomethyl)furan, and mixtures thereof. In preferred embodiments, the diacid is adipic acid and the diamine is hexamethylene diamine which are polymerized to form PA6,6.

It should be understood that the concept of producing a polyamide from diamines and diacids also encompasses the concept of other suitable monomers, such as, aminoacids or lactams. Without limiting the scope, examples of aminoacids can include 6-aminohaxanoic acid, 7-aminoheptanoic acid, 11-aminoundecanoic acid, 12-aminododecanoic acid, or combinations thereof. Without limiting the scope of the disclosure, examples of lactams can include caprolactam, enantholactam, lauryllactam, or combinations thereof. Suitable feeds for the disclosed process can include mixtures of diamines, diacids, aminoacids and lactams.

In some cases, the polyamide composition is polymerized using a conventional melt polymerization process. In one aspect, the aqueous monomer solution is heated under controlled conditions of time, temperature, and pressure to evaporate water, effect polymerization of the monomers and provide a polymer melt.

In one embodiment, a nylon is prepared by a conventional melt polymerization of a nylon salt. Typically, the nylon salt solution is heated under pressure, e.g. 250 psig/1825×10³ n/m², to a temperature of, for example, about 245° C. Then the water vapor is exhausted off by reducing the pressure to atmospheric pressure while increasing the temperature to, for example, about 270° C. The resulting molten nylon is held at this temperature for a period of time to bring it to equilibrium prior to being extruded into a fiber. In some aspects, the process may be carried out in a batch or continuous process.

In some aspects, the fabric is melt blown. Melt blowing is advantageously less expensive than electrospinning. Melt blowing is a process type developed for the formation of microfibers and nonwoven webs. Until recently, microfibers have been produced by melt blowing. Now, nanofibers may also be formed by melt blowing. The nanofibers are formed by extruding a molten thermoplastic polymeric material, or polyamide, through a plurality of small holes, e.g., in a spinneret. Appropriate relative viscosity is required, see discussion above. The resulting molten threads or filaments pass into converging high velocity gas streams which attenuate or draw the filaments of molten polyamide to reduce their diameters. Thereafter, the melt blown nanofibers are carried by the high velocity gas stream and deposited on a collecting surface, or forming wire, to form a nonwoven web of randomly disbursed melt blown nanofibers. The formation of nanofibers and nonwoven webs by melt blowing is well known in the art. See, e.g., U.S. Pat. Nos. 3,704,198; 3,755,527; 3,849,241; 3,978,185; 4,100,324; and 4,663,220.

One option, “Island-in-the-sea,” refers to fibers forming by extruding at least two polymer components from one spinning die, also referred to as conjugate spinning.

As is well known, electrospinning has many fabrication parameters that may limit spinning certain materials. These parameters include: electrical charge of the spinning material and the spinning material solution; solution delivery (often a stream of material ejected from a syringe); charge at the jet; electrical discharge of the fibrous membrane at the collector; external forces from the electrical field on the spinning jet; density of expelled jet; and (high) voltage of the electrodes and geometry of the collector. In contrast, the aforementioned nanofibers and products are advantageously formed without the use of an applied electrical field as the primary expulsion force, as is required in an electrospinning process. Thus, the polyamide is not electrically charged, nor are any components of the spinning process. Importantly, the dangerous high voltage necessary in electrospinning processes, is not required with the presently disclosed processes/products. In some embodiments, the process is a non-electrospin process and resultant product is a non-electrospun product that is produced via a non-electrospin process.

Another embodiment of making the nanofiber nonwovens is by way of 2-phase spinning or melt blowing with propellant gas through a spinning channel as is described generally in U.S. Pat. No. 8,668,854. This process includes two phase flow of polymer or polymer solution and a pressurized propellant gas (typically air) to a thin, preferably converging channel. The channel is usually and preferably annular in configuration. It is believed that the polymer is sheared by gas flow within the thin, preferably converging channel, creating polymeric film layers on both sides of the channel. These polymeric film layers are further sheared into nanofibers by the propellant gas flow. Here again, a moving collector belt may be used and the basis weight of the nanofiber nonwoven is controlled by regulating the speed of the belt. The distance of the collector may also be used to control fineness of the nanofiber nonwoven.

Beneficially, the use of the aforementioned polyamide precursor in the melt spinning process provides for significant benefits in production rate, e.g., at least 5% greater, at least 10% greater, at least 20% greater, at least 30% greater, at least 40% greater. The improvements may be observed as an improvement in area per hour versus a conventional process, e.g., another process that does not employ the features described herein. In some cases, the production increase over a consistent period of time is improved. For example, over a given time period, e.g., one hour, of production, the disclosed process produces at least 5% more product than a conventional process or an electrospin process, e.g., at least 10% more, at least 20% more, at least 30% more, or at least 40% more.

Still yet another methodology which may be employed is melt blowing. Melt blowing involves extruding the polyamide into a relatively high velocity, typically hot, gas stream.

U.S. Pat. No. 7,300,272 (incorporated herein by reference) discloses a fiber extrusion pack for extruding molten material to form an array of nanofibers that includes a number of split distribution plates arranged in a stack such that each split distribution plate forms a layer within the fiber extrusion pack, and features on the split distribution plates form a distribution network that delivers the molten material to orifices in the fiber extrusion pack. Each of the split distribution plates includes a set of plate segments with a gap disposed between adjacent plate segments. Adjacent edges of the plate segments are shaped to form reservoirs along the gap, and sealing plugs are disposed in the reservoirs to prevent the molten material from leaking from the gaps. The sealing plugs can be formed by the molten material that leaks into the gap and collects and solidifies in the reservoirs or by placing a plugging material in the reservoirs at pack assembly. This pack can be used to make nanofibers with a melt blowing system described in the patents previously mentioned. The systems and method of U.S. Pat. No. 10,041,188 (incorporated herein by reference) are also exemplary.

If fibers are produced, a fabric can be made from the fibers by conventional means.

### Fiber/Fabric Characteristics

In some embodiments, the fabric comprises a plurality of fibers having an average fiber diameter less than 50 microns, e.g., less than 45 microns, less than 40 microns, less than 35 microns, less than 30 microns, less than 25 microns, less than 20 microns, less than 15 microns, less than 10 microns, or less than 5 microns. In terms of lower limits, the plurality of fibers may have an average fiber diameter greater than 1 micron, e.g., greater than 1.5 microns, greater than 2 microns, greater than 2.5 microns, greater than 5 microns, or greater than 10 microns. In terms of ranges, the plurality of fibers may have an average fiber diameter from 1 micron to 50 microns, e.g., from 1 micron to 45 microns, from 1 micron to 40 microns, from 1 micron to 35 microns, from 1 micron to 30 microns, from 1 micron to 20 microns, from 1 micron to 15 microns, from 1 micron to 10 microns, from 1 micron to 5 microns, from 1.5 microns to 25 microns, from 1.5 microns to 20 microns, from 1.5 microns to 15 microns, from 1.5 microns to 10 microns, from 1.5 microns to 5 microns, from 2 microns to 25 microns, from 2 microns to 20 microns, from 2 microns to 15 microns, from 2 microns to 10 microns, from 2 microns to 5 microns, from 2.5 microns to 25 microns, from 2.5 microns to 20 microns, from 2.5 microns to 15 microns, from 2.5 microns to 10 microns, from 2.5 microns to 5 microns, from 5 microns to 45 microns, from 5 microns to 40 microns, from 5 microns to 35 microns, from 5 microns to 30 microns, from 10 microns to 45 microns, from 10 microns to 40 microns, from 10 microns to 35 microns, from 10 microns to 30 microns. In some cases, fibers of this size may be referred to as microfibers.

In some embodiments, the fabric comprises a plurality of fibers having an average fiber diameter less than 1 micron, e.g., less than 0.9 microns, less than 0.8 microns, less than 0.7 microns, less than 0.6 microns, less than 0.5 microns, less than 0.4 microns, less than 0.3 microns, less than 0.2 microns, less than 0.1 microns, less than 0.05 microns, less than 0.04 microns, or less than 0.03 microns. In terms of lower limits, the average fiber diameter of the plurality of fibers may be greater than 1 nanometer, e.g., greater than 10 nanometers, greater than 25 nanometers, or greater than 50 nanometers. In terms of ranges, the average fiber diameter of the plurality of fibers may be from 1 nanometer to 1 micron, e.g., from 1 nanometer to 0.9 microns, from 1 nanometer to 0.8 microns, from 1 nanometer to 0.7 microns, from 1 nanometer to 0.6 microns, from 1 nanometer to 0.5 microns, from 1 nanometer to 0.4 microns, from 1 nanometer to 0.3 microns, from 1 nanometer to 0.2 microns, from 1 nanometer to 0.1 microns, from 1 nanometer to 0.05 microns, from 1 nanometer to 0.04 microns, from 1 nanometer to 0.3 microns, from 10 nanometers to 1 micron, from 10 nanometers to 0.9 microns, from 10 nanometers to 0.8 microns, from 10 nanometers to 0.7 microns, from 10 nanometers to 0.6 microns, from 10 nanometers to 0.5 microns, from 10 nanometers to 0.4 microns, from 10 nanometers to 0.3 microns, from 10 nanometers to 0.2 microns, from 10 nanometers to 0.1 microns, from 10 nanometers to 0.05 microns, from 10 nanometers to 0.04 microns, from 10 nanometers to 0.03 microns, from 25 nanometers to 1 micron, from 25 nanometers to 0.9 microns, from 25 nanometers to 0.8 microns, from 25 nanometers to 0.7 microns, from 25 nanometers to 0.6 microns, from 25 nanometers to 0.5 microns, from 25 nanometers to 0.4 microns, from 25 nanometers to 0.3 microns, from 25 nanometers to 0.2 microns, from 25 nanometers to 0.1 microns, from 25 nanometers to 0.05 microns, from 25 nanometers to 0.04 microns, from 25 nanometers to 0.03 microns, from 50 nanometers to 1 micron, from 50 nanometers to 0.9 microns, from 50 nanometers to 0.8 microns, from 50 nanometers to 0.7 microns, from 50 nanometers to 0.6 microns, from 50 nanometers to 0.5 microns, from 50 nanometers to 0.4 microns, from 50 nanometers to 0.3 microns, from 50 nanometers to 0.2 microns, from 50 nanometers to 0.1 microns, from 50 nanometers to 0.05 microns, from 50 nanometers to 0.04 microns, or from 50 nanometers to 0.03 microns. In some cases, fibers of this size may be referred to as nanofibers.

In some cases, the fabric/layer has a thickness ranging from 0.05 mm to 10 mm, e.g., from 0.05 mm to 7 mm microns, from 0.1 mm to 2.0 mm, or from 0.3 mm to 1.0 mm, or from 0.4 mm to 0.8 mm. In terms of upper limits, the fabric/layer may have a thickness less than 10 mm, e.g., less than 8 mm, less than 7 mm, less than 5 mm, less than 3 mm, less than 2 mm, or less than 1 mm. In terms of lower limits, the fabric/layer may have a thickness greater than 0.05 mm, e.g., greater than 0.07 mm, greater than 0.1 mm, greater than 0.3 mm, greater than 0.4 mm, or greater than 0.5 mm.

It has been found that the fabric may advantageously be composed of a relatively hydrophilic and/or hygroscopic material. A polymer of increased hydrophilicity and/or hygroscopy may better attract and hold moisture and/or to manage moisture when worn. As discussed below, improved, e.g., increased, hydrophilicity and/or hygroscopy may be accomplished by utilizing the polymer compositions described herein. In some cases, the hydrophilicity and/or hygroscopy of the improved fibers/fabrics may be measured by saturation. In some cases, the hydrophilicity and/or hygroscopy of a given layer of the fibers/fabrics may be measured by the amount of water it can absorb (as a percentage of total weight). In some embodiments, the layer is capable of absorbing greater than 1.5 wt. % water, based on the total weight of the polymer, e.g., greater than 2.0 wt. %, greater than 3.0%, greater than 5.0 wt. %, greater than 7.0 wt. %, greater than 10.0 wt. %. or greater than 25.0 wt. %. In terms of ranges, the hydrophilic and/or hygroscopic polymer may be capable of absorbing water in an amount ranging from 1.5 wt. % to 50.0 wt. %, e.g., from 1.5 wt. % to 14.0 wt. %, from 1.5 wt. % to 9.0 wt. %, from 2.0 wt. % to 8 wt. %, from 2.0 wt. % to 7 w %, from 2.5 wt. % to 7 wt. %, or from 1.5 wt. % to 25.0 wt. %.

### Performance Characteristics

The performance of the fibers/fabrics described herein may be assessed using a variety of conventional metrics.

In some cases, the protective fabric demonstrates a flame retardant index greater than 2, as measured in accordance with ISO 14116:2008, e.g., greater than 2.5, greater than 3.0, greater than 3.5, greater than 4.0, greater than 4.5, or greater than 5.0.

In some cases, the protective fabric demonstrates a (warp) tensile strength greater than 500N, as measured in accordance with BS EN ISO 13934-1:1999, e.g. greater than 600N, greater than 650N, greater than 700N, greater than 750N, greater than 800N, or greater than 900N.

In some cases, the protective fabric demonstrates a (weft) tensile strength greater than 200N, as measured in accordance with BS EN ISO 13934-1:1999, e.g. greater than 250N, greater than 300N, greater than 350N, greater than 360N, greater than 400N, or greater than 500N.

In some cases, the protective fabric demonstrates a (warp) tear strength greater than 25N, as measured in accordance with BS EN ISO 13937-3:2000, e.g. greater than 35N, greater than 40N, greater than 45N, greater than 50N, greater than 60N, or greater than 70N.

In some cases, the protective fabric demonstrates a (weft) tear strength greater than 25N, as measured in accordance with BS EN ISO 13937-3:2000, e.g. greater than 35N, greater than 40N, greater than 45N, greater than 50N, greater than 60N, or greater than 70N.

In some cases, the protective fabric demonstrates an abrasion resistance greater than 12,000 revs (at 9 KPa), as measured in accordance with BS EN ISO 12947-2:2016, e.g. greater than 13,000 revs, greater than 14,000 revs, greater than 15,000 revs, greater than 16,000 revs, greater than 17,000 revs, greater than 18,000 revs, or greater than 20,000 revs.

In some cases, the protective fabric demonstrates a water vapor resistance (Ret) greater than 4.00 m²Pa/W, as measured in accordance with ISO 11092:2014, e.g. greater than 4.25 m²Pa/W, greater than 4.5 m²Pa/W, greater than 4.66 m²Pa/W, greater than 4.70 m²Pa/W, greater than 4.75 m²Pa/W, or greater than 5.0 m²Pa/W.

In some cases, the protective fabric demonstrates a thermal resistance (Rct) greater than 0.01 m²K/W, as measured in accordance with ISO 11092:2014, e.g. greater than 0.03 m²K/W, greater than 0.05 m²K/W, greater than 0.07 m²K/W, greater than 0.10 m²K/W, greater than 0.12 m²K/W, or greater than 0.15 m²K/W.

In some cases, the protective fabric demonstrates an air permeability greater than 25.0 mm/sec, as measured in accordance with ISO 9237:2015, e.g. greater than 30.0 mm/sec, greater than 32.0 mm/sec, greater than 34.3 mm/sec, greater than 36.0 mm/sec, greater than 40.0 mm/sec, or greater than 45 mm/sec.

The strength of a polymer composition can also be characterized in terms of its elongation properties. It can be beneficial for polymeric materials to have high elongation because products manufactured from these materials are often subjected to stretching forces that can cause a material with low elongation to tear or rupture. Elongation can be measured with, for example, the standard test method ASTM D882-18 (2018) or ISO 527-2 (2012).

The tensile modulus of a polymer composition is a measure of the resistance of the composition to stretching forces. It can be beneficial for polymeric compositions to have low tensile moduli, because a lower modulus can increase the elasticity of products manufactured from the compositions and render these products more amenable to processing steps that involve stretching or thermoforming. Tensile moduli can be measured with, for example, the standard test method ASTM D882-18 (2018) or ISO 527-2 (2012).

As used herein, “greater than” and “less than” limits may also include the number associated therewith. Stated another way, “greater than” and “less than” may be interpreted as “greater than or equal to” and “less than or equal to.” It is contemplated that this language may be subsequently modified in the claims to include “or equal to.” For example, “greater than 4.0” may be interpreted as, and subsequently modified in the claims as “greater than or equal to 4.0.”

In some embodiments, any or some of the components or steps disclosed herein may be considered optional. In some cases, the disclosed compositions may expressly exclude any or some of the aforementioned components or steps in this description, e.g., via claim language. For example, claim language may be modified to recite that the disclosed compositions, materials processes, etc., do not utilize or comprise one or more of the aforementioned additives, e.g., the disclosed materials do not comprise a flame retardant or a delusterant. As another example, the claim language may be modified to recite that the disclosed materials do not comprise long chain polyamide component, e.g., PA-12. Such negative limitations are contemplated, and this text serves as support for negative limitations for components, steps, and/or features.

### Embodiments

As used below, any reference to a series of embodiments is to be understood as a reference to each of those embodiments disjunctively (e.g., “Embodiments 1-4” is to be understood as “Embodiments 1, 2, 3, or 4”).

Embodiment 1 is a protective fabric or layer having improved chem/bio repellant properties, comprising a fiber matrix, preferably a nonwoven fiber matrix, comprising fibers; and metal oxide particles dispersed among the fibers; wherein the fiber matrix has a metal oxide particle retention rate greater than 5%; and wherein the protective fabric demonstrates a flame retardant index greater than 2, as measured in accordance with ISO 14116:2008.

Embodiment 2 is an embodiment of embodiment 1, wherein the fiber matrix is a spunbond fabric.

Embodiment 3 is an embodiment of embodiment 1 or 2, wherein the metal oxide particles are embedded among the fibers.

Embodiment 4 is an embodiment of any of embodiments 1-3, wherein the metal oxide particles comprise aluminum oxide or titanium oxide or combinations thereof.

Embodiment 5 is an embodiment of any of embodiments 1-4, wherein the metal oxide particles are particles having an average particle diameter less than 2 microns.

Embodiment 6 is an embodiment of any of embodiments 1-5, wherein the fibers comprise first fibers made from a first fiber/fabric composition comprising a first polymer, preferably a polyamide.

Embodiment 7 is an embodiment of any of embodiments 1-6, wherein the fibers comprise second fibers made from a second fiber/fabric composition comprising a second component, preferably cotton.

Embodiment 8 is a process for making a protective fabric, the process comprising embedding metal oxide particles into a fiber matrix of fibers to yield the protective fabric; wherein the fiber matrix has an oxide particle retention rate greater than 5%; and wherein the protective fabric demonstrates a flame retardant index greater than 3, as measured in accordance with ISO 14116:2008.

Embodiment 9 is an embodiment of embodiment 8, wherein the embedding comprises: providing the fiber matrix; and adding the metal oxide particles to the fiber matrix to form an intermediate matrix.

Embodiment 10 is an embodiment of embodiment 8 or 9, wherein the embedding comprises needle punching the intermediate matrix to embed the metal oxide particles therein.

Embodiment 11 is an embodiment of any of embodiments 8-10, wherein the embedding comprises sandwiching metal oxide particles between a first fiber matrix and a second fiber matrix to form an intermediate matrix and needle punching the intermediate matrix to embed the metal oxide particles therein.

Embodiment 12 is an embodiment of any of embodiments 8-11, wherein the embedding comprises hydroentangling the fibers and adding the metal oxide particles to the hydroentangled fibers.

Embodiment 13 is an embodiment of any of embodiments 8-12, wherein the embedding comprises adding the metal oxide particles to the fiber matrix to form an intermediate matrix; and pressurizing the intermediate matrix to embed the metal oxide particles therein.

Embodiment 14 is an embodiment of any of embodiments 8-13, further comprising: forming the protective fabric into a chem/bio garment.

Embodiment 15 is a chem/bio garment comprising a fiber matrix layer comprising fibers and metal oxide particles dispersed among the fibers; wherein the fiber matrix has an oxide particle retention rate greater than 5%; and wherein the chem/bio garment demonstrates a flame retardant index greater than 3, as measured in accordance with ISO 14116:2008.

We claim:

1. A protective fabric having improved chem/bio repellant properties, comprising:
a fiber matrix comprising:
fibers; and
metal oxide particles dispersed among the fibers;
wherein the fiber matrix has a metal oxide particle retention rate greater than 5%; and
wherein the protective fabric demonstrates a flame retardant index greater than 2, as measured in accordance with ISO 14116:2008.

2. The protective fabric of claim 1, wherein the fiber matrix is a spunbond fabric.

3. The protective fabric of claim 1, wherein the fiber matrix is a nonwoven fiber matrix.

4. The protective fabric of claim 1, wherein the metal oxide particles are embedded among the fibers.

5. The protective fabric of claim 1, wherein the metal oxide particles comprise aluminum oxide or titanium oxide or combinations thereof.

6. The protective fabric of claim 1, wherein the metal oxide particles have an average particle diameter less than 2 microns.

7. The protective fabric of claim 1, wherein the fibers comprise first fibers made from a first fiber/fabric composition comprising a first polymer.

8. The protective fabric of claim 7, wherein the fibers comprise second fibers made from a second fiber/fabric composition comprising a second component.

9. The protective fabric of claim 8, wherein the first fiber/fabric composition comprises a polyamide and the second fiber/fabric composition comprises cotton.

10. A process for making a protective fabric, the process comprising:
embedding metal oxide particles into a fiber matrix of fibers to yield the protective fabric;
wherein the fiber matrix has an oxide particle retention rate greater than 5%; and
wherein the protective fabric demonstrates a flame retardant index greater than 3, as measured in accordance with ISO 14116:2008.

11. The process of claim 8, wherein the embedding comprises:
providing the fiber matrix; and
adding the metal oxide particles to the fiber matrix to form an intermediate matrix.

12. The process of claim 11, wherein the embedding comprises:
needle punching the intermediate matrix to embed the metal oxide particles therein.

13. The process of claim 10, wherein the embedding comprises:
sandwiching metal oxide particles between a first fiber matrix and a second fiber matrix to form an intermediate matrix; and
needle punching the intermediate matrix to embed the metal oxide particles therein.

14. The process of claim 10, wherein the embedding comprises:
hydroentangling the fibers; and
adding the metal oxide particles to the hydroentangled fibers.

15. The process of claim 10, wherein the embedding comprises:
adding the metal oxide particles to the fiber matrix to form an intermediate matrix; an pressurizing the intermediate matrix to embed the metal oxide particles therein.

16. The process of claim 10, wherein the fibers comprise first fibers made from a first fiber/fabric composition comprising a polyamide and second fibers made from a second fiber/fabric composition comprising cotton.

17. The process of claim 10, wherein the metal oxide particles have an average particle diameter less than 2 microns.

18. The process of claim 10, further comprising: forming the protective fabric into a chem/bio garment.

19. A chem/bio garment comprising:
a fiber matrix layer comprising:
fibers; and
metal oxide particles dispersed among the fibers;
wherein the fiber matrix has an oxide particle retention rate greater than 5%; and
wherein the chem/bio garment demonstrates a flame retardant index greater than 3, as measured in accordance with ISO 14116:2008.

20. The chem/bio garment of claim 19, wherein the metal oxide particles have an average particle diameter less than 2 microns.
